(19) United States
(12) Patent Application Publication
(10) Pub. No.: US 2006/0177635 A1
(43) Pub. Date: Aug. 10, 2006

(54) Two-layer structural material with interdigitated protrusions

(76) Inventors: Timothy Patrick Pepe, Centennial, CO (US); Mark William Massman, Redmond, WA (US); Jon W. Neal, Parker, CO (US); Peter Foley, Castle Rock, CO (US)

Correspondence Address: WONG, CABELLO, LUTSCH, RUTHERFORD & BRUCCULERI,;L.L.P., 20333 SH 249, SUITE 600, HOUSTON, TX, 77070, US

(21) Appl. No.: 11/299,319

(22) Filed: Dec. 9, 2005

Related U.S. Application Data
(60) Provisional application No. 60/634,928, filed on Dec. 10, 2004.

(51) Int. Cl. B32B 1/00

(52) U.S. Cl. 428/174

(57) ABSTRACT

A two-layer structural material of sandwich design is disclosed which comprises opposed, generally planar sheets having interlocking protrusions. The material may be formed of plastic resin, metal, paper, paperboard, or composite material and has increased rigidity over single sheet material without the complexity of 3-layer materials such as corrugated board and honeycomb-cored structures.

### CROSS-REFERENCES TO RELATED APPLICATION

This application claims the benefit under 35 U.S.C. § 119(e) of U.S. Provisional Patent Application No. 60/634,928, filed Dec. 10, 2004, which is incorporated herein by reference.

### BACKGROUND OF THE INVENTION

1. Field of the Invention.

This invention relates to structural sheet goods which may be cut, folded or formed into a variety of articles. More particularly, it relates to a 2-layer material having opposing protrusions.

2. Description of the Related Art.

Corrugated board (paper- and plastic-based), honeycomb structures and similar “sandwich-type” materials are well-known in the art for use in manufacturing a wide variety of articles. These materials are typically comprised of three layers—opposed, generally planar, top and bottom layers and, a third, interior layer which physically joins the top and bottom layers. In corrugated board, this third layer is the corrugated layer. In honeycomb sandwich material, the third layer is the honeycomb-like structure.

Sandwich type structures comprised of opposing sheets of elastomeric material having protrusions which abut in the cavity or space between the opposing sheets are also known in the art.

U.S. Pat. No. 6,098,313 discloses a high polymer resin material configured into a shoe sole component having a plurality of inwardly extending indentations in one or both of the top and bottom members of the component. The indentations extend into the interval between the members and adjacent to the opposite member to provide support members for the sole component. The sole component can be constructed by molding upper and lower sole component halves wherein the molds are configured to provide indentations in the top and bottom members. The upper and lower sole component halves are then joined to complete the sole component.

U.S. Pat. No. 6,029,962 discloses a shock absorbing component having a pair of surfaces with a plurality of inwardly extending indentations in the top and bottom surfaces. The indentations extend between the surfaces to provide support members for the shock absorbing component. The surfaces may be formed of mesh material to allow the passage of gas or fluid. One or more inserts may be placed in the indentations. The shock absorbing component can be constructed by molding upper and lower shock absorbing component halves wherein the molds are configured to provide indentations in the top and bottom surfaces. The upper and lower halves are then joined to complete the shock absorbing component.

U.S. Pat. No. 5,976,451 discloses a process for making a cushioning component from a pair of sheets of flexible thermoplastic resin in which the sheets are placed against a pair of molds having hemispherical protrusions for forming opposing hemispherical indentations in the sheets. The indentations in the first sheet abut those of the second sheet when the sheets are joined to complete the cushioning component. During the process, inserts may be positioned on the protrusions before the sheets are placed in the molds, and the inserts then may be adhered to the indentations during molding.

U.S. Pat. No. 5,572,804 discloses a high polymer resin material that is configured into a shoe sole component having a plurality of inwardly extending indentations in one or both of the top and bottom members of the component. The indentations extend into the interval between the members and adjacent to the opposite member to provide support members for the sole component. The sole component can be constructed by molding upper and lower sole component halves wherein the molds are configured to provide indentations in the top and bottom members. The upper and lower sole component halves are then joined to complete the sole component.

Commonly-owned U.S. patent application Ser. No. 60/546,539 filed Feb. 20, 2004 discloses a material used for anti-fatigue mats which may comprise an array of opposed, twin hemispheres formed in plastic.

And, commonly-owned U.S. patent application Ser. No. 10/263,602 filed Oct. 3, 2002 discloses a cushioned pole vault planting box having cushioning material which may be a twin sheet cushioning material having generally hemispherical or hemi-ellipsoidal resilient indentations.

The disclosures of each of the above-mentioned patents and patent applications are hereby incorporated by reference.

### SUMMARY OF THE INVENTION

It has been unexpectedly found that when a construct generally in the form of that disclosed in U.S. Pat. No. 6,029,962 but fabricated with material of limited elasticity and/or with the opposing protrusions interdigitated rather than abutting, a material of surprising strength and rigidity is produced. In one alternative embodiment, abutting protrusions such as those disclosed in U.S. Pat. No. 6,029,962 may be utilized even with materials other than elastomers such as, for example, un-cross-linked polyolefins that are thermoplastic generally known as thermoplastic polyolefin (“TPO”) rubbers, other synthetic polymer plastics, kraft paper, paperboard, metal foils and composite materials. Unlike the materials of the prior art, an article according to the present invention may consist of only two layers—thereby saving cost, complexity and weight.

### BRIEF DESCRIPTION OF THE DRAWING FIGURES

FIG. 1A is a top plan view of a portion of one embodiment of the invention.

FIG. 1B is a top plan view of a portion of an alternative embodiment of the invention.

FIG. 1C is a top plan view of a portion of a third embodiment of the invention.

FIG. 2 is a cross sectional view of a portion of one embodiment of the invention.

FIG. 3 is a top plan view, partially in phantom, of a sheet of structural material according to one embodiment of the invention.

FIG. 4 is a cross-sectional view of the sheet illustrated in FIG. 3.

FIG. 5 is a perspective view of the sheet illustrated in FIG. 3.

FIG. 5A is an enlarged view of the portion of FIG. 5 identified as “A”.

FIG. 6 is a top plan view, partially in phantom, of a portion of a sheet of structural material according to another embodiment of the invention.

FIGS. 7A, 7B and 7C are perspective views of the embodiments illustrated in FIGS. 1A, 1B and 1C, respectively.

FIGS. 8A, 8B and 8C are cross-sectional views of abutting embodiments using the protrusion embodiments illustrated in FIGS. 1A, 1B and 1C, respectively.

FIG. 9 is a top plan view, partially in phantom, of a portion of a sheet of structural material according to an embodiment of the invention which additionally comprises support ribs.

FIG. 10 is a perspective view of the embodiment illustrated in FIG. 9.

FIGS. 11A and 11B are orthogonal cross-sectional views of the embodiment illustrated in FIG. 9.

FIG. 12 is an enlarged view of the indicated portion of FIG. 11A.

### DETAILED DESCRIPTION

The present invention comprises a novel material that provides structural rigidity in twp layers. In certain embodiments, the two layers are essentially parallel and joined by protrusions that may take the form of hemispheres, ellipses, pyramids, boxes [4-sided structures], pentagons, hexagons or any such structure with a greater number of sides similar to the cushioning material described in U.S. Pat. No. 6,029,962 but with the protrusions interdigitated rather than abutting. Unlike the cushioning material of U.S. Pat. No. 6,029,962 (which is most commonly fabricated using elastomeric material), the present invention may advantageously employ a variety of materials including, without limitation, plastic material, composite material, paper, paperboard and metals. The stiffness of the material may be varied using different geometry, spacing and materials in one or both of the layers (sheets). Tuning the layout and variation of protrusion size and shape allows one to vary the torsional properties across a part made using the material according to the present invention. In various embodiments, the protrusions in the opposing layers (sheets) may be either aligned or offset.

Plastics are called plastic because they are pliable, that is, they can be shaped and molded easily. Inasmuch as plastics become easier to mold and shape when they're hot, and melt when they get hot enough, we call them thermoplastics. This name distinguishes them from cross-linked materials that don't melt, called thermosets.

We distinguish here between plastic material and a rubber material or elastomer. One can stretch an elastomer, and it bounces back. Plastics tend to either deform permanently, or just plain break, when stretched too hard.

Elastomers were originally defined to be synthetic thermosetting high polymers having properties similar to those of vulcanized natural rubber, namely, the ability to the stretched to at least twice their original length and to retract very rapidly to approximately their original length when released. Included are styrene-butadiene copolymer, polychloroprene (neoprene) nitrile rubber, butyl rubber, polysulfide rubber, EPDM rubber, silicone rubber and polyurethane rubbers. These can be cross-linked with sulfur, peroxides, or similar agents. The term “elastomer” was later extended to include un-cross-linked polyolefins that are thermoplastic; these are generally known as TPO rubbers (thermoplastic polyolefin rubber). Their extension and retraction properties are notably different from those of thermosetting elastomers.

Although plastics don't behave as well as rubber when they're stretched, it takes a lot more energy to stretch them in the first place—i.e., plastics resist deformation better than elastomers do. This is a desirable property when one does not want a material to stretch.

Although plastics are called “plastic” because one can deform them and mold them, it takes more energy to stretch plastic, making it resistant to deformation. But at the same time, if you pull hard enough, you can not only stretch a plastic, but it will stay in the shape you stretched it into once you stop stretching it. Elastomers bounce back when the strain is released. And plastics are also much more pliable than some other materials.

Examples of plastics that may be employed in the practice of the present invention include: ABS (acrlyonitrile-butadiene-styrene); Polyethylene; Polypropylene; Polystyrene; Polyesters; Polycarbonate; PVC (polyvinyl chloride); Nylon; and PMMA (polymethyl methacrylate). Foamed plastic materials may also be advantageously used.

Examples of composite materials that may be employed in the practice of the present invention include: fiberglass and other reinforced plastics, carbon fiber composites, laminates of paper, fabric or wood and a thermosetting material, and filled composites in which a bonding material is loaded with a filler in the form of flakes or small particles.

Metals that may be used to advantage in the practice of the present invention include especially those that may be readily formed into sheets and stamped to provide the above-described protrusions. Examples of such metals include: aluminum, steel (including coated and treated steels such as galvanized steel); tin; copper; and various alloys. Metals may also be molded into the form needed to practice the invention.

In general, any material that may be molded or formed into a sheet having the requisite protrusions and joined to another such sheet may be used in the practice of the present invention.

The structure of the present invention can have uniform rigidity if the protrusions are laid out in a uniform pattern and can have varying rigidity, tuned for a specific application, by varying the size, spacing and the geometry of the protrusions. The rigidity of the material may also be adjusted by varying the type and degree of bonding between the interlocked protrusions—in general, stronger adhesives and greater density of bonding sites provides a stiffer material.

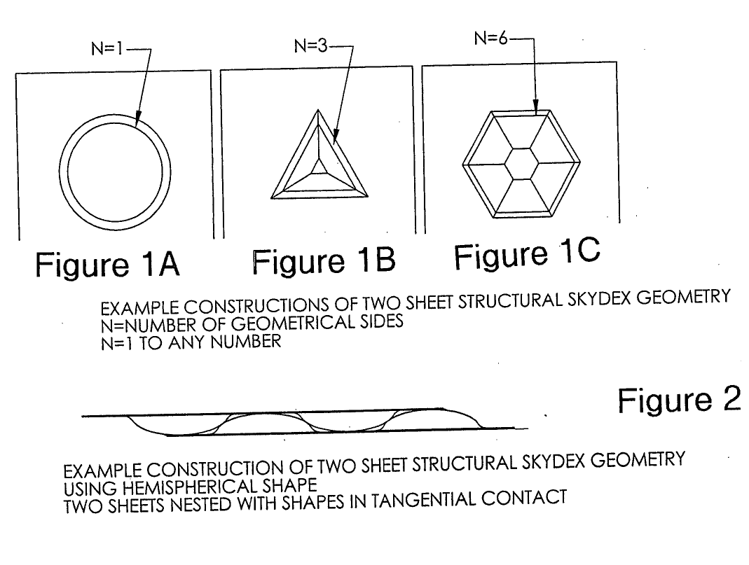

FIGS. 1A, 2 and 3 depict portions of a sheet of material made according to the present invention wherein the geometrical shape of the protrusions is generally hemispherical—i.e., wherein the number of sides N is equal to one. FIG. 2 is a cross-sectional view in which it may be seen that the generally hemispherical protrusions are in side contact with protrusions on the opposing sheet and in apical contact with the generally planar portions of the opposing sheet. Each or all of the points of contact may be the situs of a bond between the opposing sheets. The bond may be mechanical, frictional, and/or chemical. The bond may comprise a weld or an adhesive joining. In some embodiments, the bond may be provided by attractive electrical fields—i.e., static electricity.

FIG. 1B depicts a portion of a sheet of material made according to the present invention wherein the geometrical shape of the protrusions is generally trigonal pyramidal—i.e., wherein the number of sides N is equal to three. As shown in the drawing figures, the pyramid may be truncated so as to provide a generally flat “plateau” in place of an apex. In embodiments having abutting protrusions, the opposing plateaus may provide a contact area andlor a bonding area where an adhesive may be applied or a weldment located.

FIGS. 1C depicts a portion of a sheet of material made according to the present invention wherein the geometrical shape of the protrusions is generally hexagonal in cross-section—i.e., wherein the number of sides N is equal to six. This shape may also be truncated to provide a plateau, as discussed above.

FIG. 2 is a cross-sectional view of a two-sheet structural material according to one embodiment wherein the projections have a generally hemispherical shape and are sized such that when the opposing protrusions are interdigitated [nested], their sides are in approximately tangential contact.

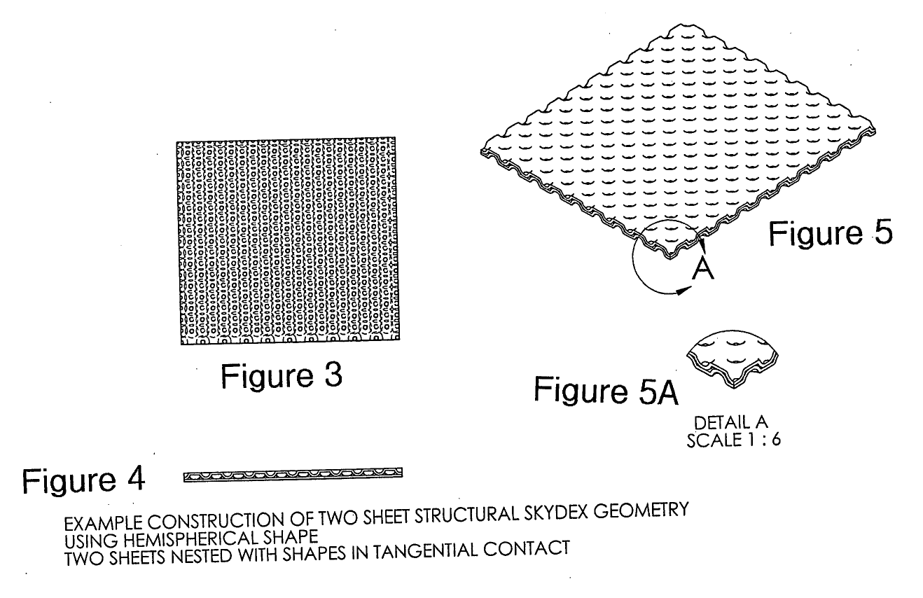

FIGS. 3,4 and 5 are top plan, cross-sectional and perspective views, respectively, of a sheet of material according to the present invention. Protrusions in the bottom sheet are shown in phantom in FIG. 3. In the particular embodiment illustrated, the protrusions in the bottom sheet are displaced from those in the top sheet by ½ the distance between protrusions in each sheet. In this embodiment, the offset [or displacement] of protrusions in the opposing sheets is in one dimension—i.e., the protrusions in the top and bottom sheets are aligned in columns, but displaced by ½ row. This embodiment has the added advantage of providing a “tunnel” for airflow between columns.

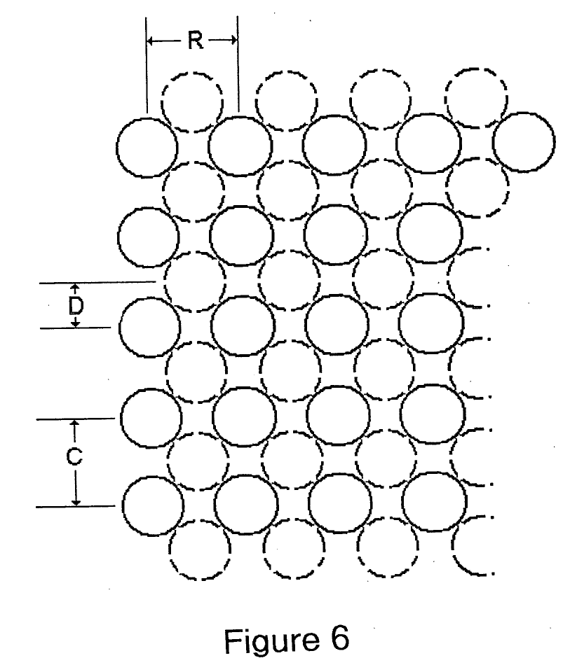

FIG. 6 is a top plan view of a portion of a sheet of material according to the present invention. Hemispherical protrusions 62 in the bottom sheet are shown in phantom in FIG. 6. In the particular embodiment illustrated, the protrusions 62 in the bottom sheet are displaced from protrusions 60 in the top sheet by ½ the distance between protrusions in each sheet. In this embodiment, the offset D [or displacement] of protrusions in the opposing sheets is in two dimensions—i.e., the protrusions in the top and bottom sheets are displaced by ½ column C and ½ row R.

It will be appreciated by those skilled in the art that many different shapes may be used for the protrusions of the present invention—for example, a square pyramidal shape in place of the trigonal pyramidal shape illustrated in FIG. 1B.

The interdigitated projections may be joined together and/or attached to the opposing sheet by many different techniques—for example, solvent welding, ultrasonic welding, friction stir welding, various adhesives, or by the selective application of heat. In other embodiments, the protrusions may be joined by means of mechanical fasteners which may be molded or otherwise formed into the material itself. In yet other embodiments, the protrusions may be joined solely by the frictional forces between and among the interdigitated protrusions. In some embodiments, the two sheets comprising the material are bonded [or otherwise joined] at their peripheries.

It has been surprisingly found that when the present invention is applied to relatively thin plastic sheet goods (such as the polyolefins commonly used for trash bags, grocery bags, garbage can liners and the like) in the range of about ½ to about 6 mil in thickness, the “feel” of the product is significantly enhanced—i.e., the product provides the tactile sensation of a thicker material.

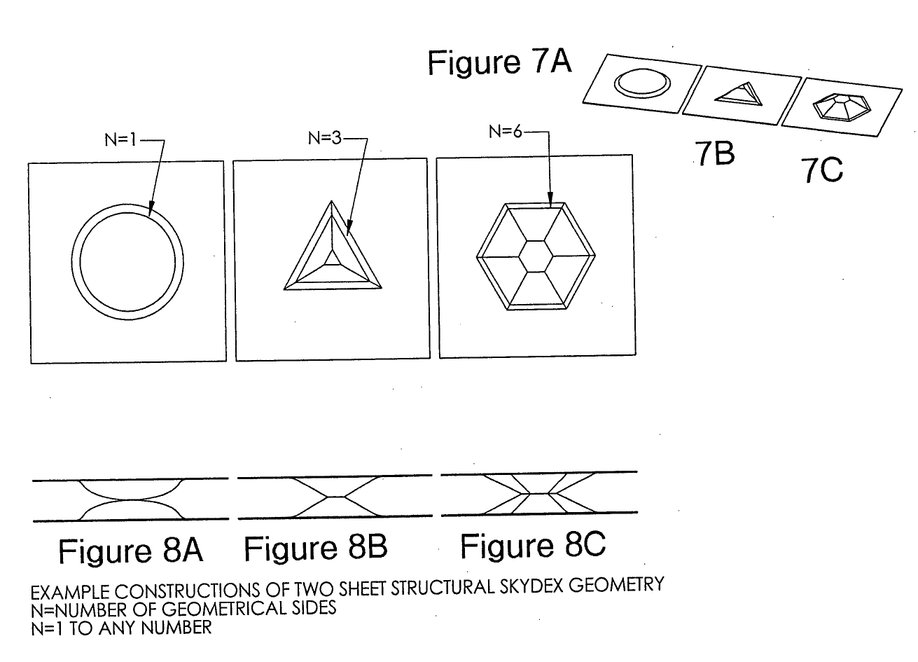

FIGS. 8A, 8B and 8C illustrate embodiments wherein the opposing protrusions are abutting, rather than interdigitated. FIG. 8A is an embodiment using the protrusion design shown in FIG. 1A; FIG. 8B is an embodiment using the protrusion design shown in FIG. 1B; and, FIG. 8C is an embodiment using the protrusion design shown in FIG. 1C.

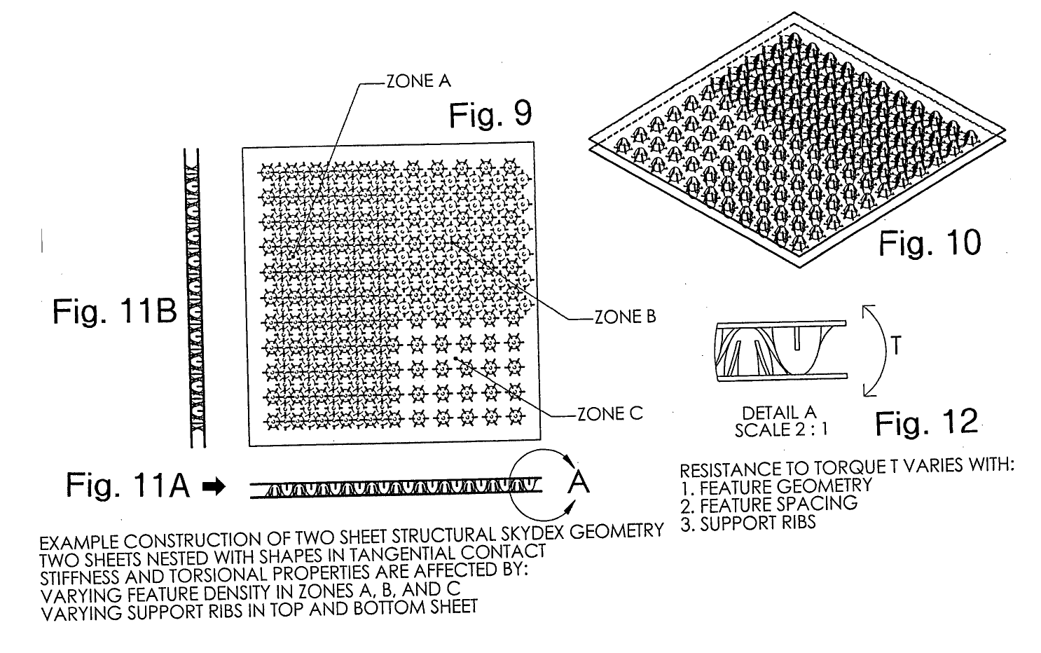

FIGS. 9 through 12, inclusive illustrate yet another embodiment of the invention. In this embodiment, the protrusions are ellipsoids provided with radially extending support ribs. The support ribs are fins or gussets that can be formed around the protrusions by either designing them into the molding tool or by relying on the natural webbing that takes place in the thermoforming process.

In the construct illustrated, two sheets of material with opposing protrusions are nested such that the protrusions on one sheet are in tangential contact with the protrusions on the opposing sheet. As shown in FIG. 9, the stiffness and torsional properties of the material may be varied by varying the feature density. In the illustrated embodiment, Zone A has the highest feature density, Zone C has the lowest feature density, and Zone B has an intermediate feature density. A sheet may have a single (i.e., uniform) feature density or, as illustrated in FIG. 9 may have regions or zones of varied feature density so as to “tune” the properties of the material for specific applications.

The stiffness and torsional resistance of the material may also be varied as may be desired by varying the number, spacing, thickness and height of the support ribs.

As shown in the detail of FIG. 12, the resistance of the material to an applied torque T varies with feature geometry, feature spacing, and support rib design.

While the present invention has been described with respect to a limited number of embodiments, those skilled in the art will appreciate numerous modifications and variations therefrom. It is intended that the appended claims cover all such modifications and variations as fall within the true spirit and scope of this present invention.

What is claimed is:

1. An article comprising:
(a) a generally planar top surface;
(b) a generally planar bottom surface in at least partially coextensive relation to said top surface to define a cavity therebetween, said coextensive relation defining opposing corresponding portions of said top and bottom surfaces;
(c) a plurality of inwardly directed indentations in both of said top and bottom surfaces extending into the cavity, a plurality of the indentations in each of the top and bottom surfaces having an outwardly facing recess, a plurality of the indentations in said top surface interdigitated with said indentations in the bottom surface.
